(19) United States
(12) Patent Application Publication
(10) Pub. No.: US 2009/0207111 A1
(43) Pub. Date: Aug. 20, 2009

(54) FULL COLOR LIGHT EMITTING DIODE DISPLAY

(75) Inventors: Chun-Wei Wang, Chu-Nan (TW); Hung-Kuang Hsu, Chu-Nan (TW)

Correspondence Address: PCE INDUSTRY, INC.;ATT. Steven Reiss, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 12/198,292

(22) Filed: Aug. 26, 2008

(30) Foreign Application Priority Data
Feb. 15, 2008 (TW) 97105333

(51) Int. Cl. G09G 3/32

(52) U.S. Cl. 345/83

(57) ABSTRACT

A full color LED display includes a plurality of pixel units. Each of the pixel units includes a first sub-pixel unit, a second sub-pixel unit and a third sub-pixel unit. The first sub-pixel unit includes a first LED chip for emitting first light of a first wavelength and a first phosphor layer associated with the first LED chip for converting the first light emitted from the first LED chip into second light of a second wavelength. The second sub-pixel unit includes a first LED chip and a second phosphor layer associated with the first LED chip, for converting the first light emitted from the first LED chip into third light of a third wavelength. The third sub-pixel unit includes a first LED chip for emitting the first light.

### CROSS REFERENCE TO RELATED APPLICATION

This application is related to commonly-assigned copending application Ser. No. 11/959,152, entitled “display device” (attorney docket number US 14125). Disclosures of the above-identified application are incorporated herein by reference.

### BACKGROUND

1. Technical Field

The present invention relates to displays, and particularly to a full color light emitting diode (LED) display.

2. Description of Related Art

In recent years, LEDs have been developed capable of emitting red, green, and blue light. The LEDs have been increasingly used for various applications such as a full-color LED displays. Typically, three LEDs emitting red, green, and blue light respectively are used to cooperate so that the red, green, and blue light are combined in a pre-determined ratio to form colored light with high brightness and contrast.

However, the three LEDs emitting red, green, and blue light require different voltages applied thereto, which complicates the design process. In addition, the three LEDs have different luminescence decay characteristics when a junction temperature of each of the three LEDs is increased. Generally, the LED emitting red light has a larger luminescence decay than the LEDs emitting blue and green light, thereby causing a distortion of the color emitted. This distortion is referred to as blue shift.

What is needed, therefore, is a full color LED display, which can simplify the design process of the corresponding electrical circuit and display excellent colors.

### SUMMARY

A full color LED display includes a plurality of pixel units. Each of the pixel units includes a first sub-pixel unit, a second sub-pixel unit and a third sub-pixel unit. The first sub-pixel unit includes a first LED chip for emitting first light of a first wavelength and a first phosphor layer associated with the first LED chip for converting the first light emitted from the first LED chip into second light of a second wavelength. The second sub-pixel unit includes a first LED chip and a second phosphor layer associated with the first LED chip, for converting the first light emitted from the first LED chip into third light of a third wavelength. The third sub-pixel unit includes a first LED chip for emitting the first light.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic exploded view of a full color LED display according to a first embodiment.

FIG. 2 is a schematic, cross-sectional view of a pixel unit of the full color LED display shown in FIG. 1 as viewed along line II-II.

FIG. 3 is a schematic, cross-sectional view of a pixel unit of a full color LED display according to a second embodiment.

FIG. 4 is a schematic view of a full color LED display according to a third embodiment.

FIG. 5 is a schematic, cross-sectional view of a pixel unit of the full color LED display shown in FIG. 4 as viewed along line V-V.

FIG. 6 is a schematic, cross-sectional view of a pixel unit of a full color LED display according to a fourth embodiment.

FIG. 7 is a schematic view of a full color LED display according to a fifth embodiment.

### DETAILED DESCRIPTION OF THE EMBODIMENTS

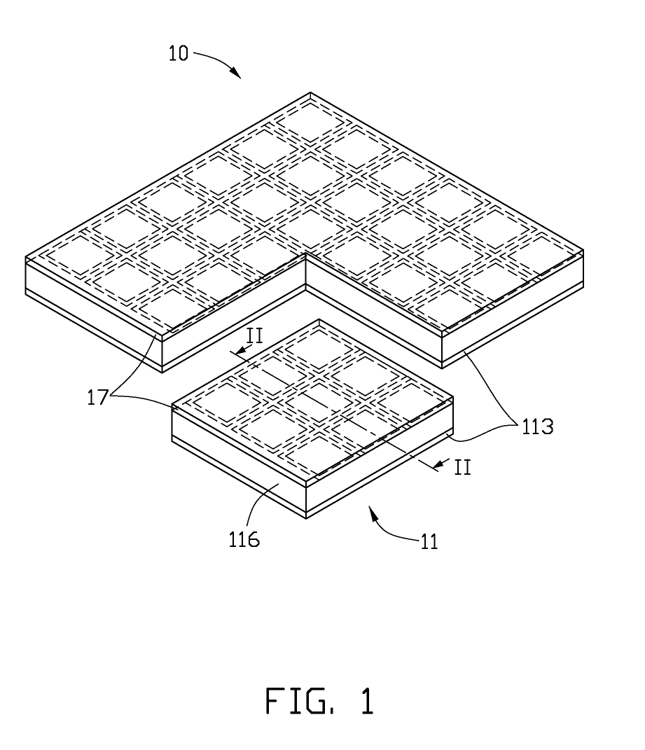

Referring to FIG. 1, an exemplary full color LED display 10 according to a first embodiment is shown. The full color LED display 10 includes a number of pixel units 11.

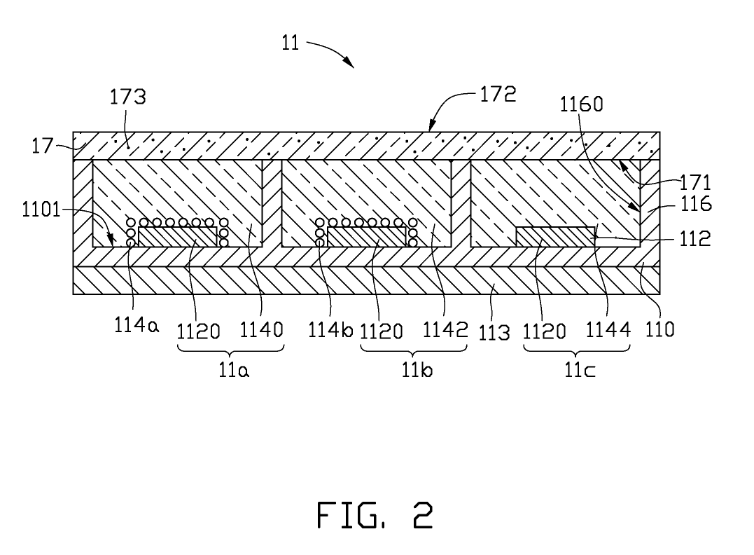

Referring to FIG. 1 and FIG. 2, each of the pixel units 11 includes at least one first sub-pixel unit 11a, at least one second sub-pixel unit 11b, and at least one third sub-pixel unit 11c. In the present embodiment, each of the pixel units 11 includes three each of the first through third sub-pixel units 11a, 11b, 11c arranged in an array.

The first sub-pixel unit 11a is configured for emitting red light. The first sub-pixel unit 11a includes a LED chip 1120 and a first filling layer 1140 encapsulating the LED chip 1120. The first filling layer 1140 is comprised of a transparent material selected from the group consisting of epoxy and silicone. The first filling layer 1140 contains a number of first phosphors 114a therein. The first filling layer 1140 has one portion adjacent to the LED chip 1120 and another portion away from the LED chip 1120. The first phosphors 114a are disposed in the one portion adjacent to the LED chip 1120. That is to say, the first phosphors 114a are disposed at an interface between the first filling layer 1140 and the LED chip 1120. Preferably, the first phosphors 114a surround the LED chip 1120 and are formed on the surface of the LED chip 1120. The first phosphors 114a are configured for converting the color of the light emitting from the LED chip 1120 to red. In the present embodiment, the first phosphors 114a are red phosphors. The LED chip 1120 emits blue light when excited. The blue light is then converted to the red light by action of the first phosphors 114a and is emitted from the first filling layer 1140.

In this embodiment, the first filling layer 1140 further contains a red dye (not shown). The red dye can be disposed in the portion away from the LED chip 1120. The red dye is configured for absorbing any blue light not contacting the first phosphors 114a to assure only red light is emitted from the first filling layer 1140.

The second sub-pixel unit 11b is configured for emitting green light. Similarly, the second sub-pixel unit 11b includes a LED chip 1120 and a second filling layer 1142 encapsulating the LED chip 1120. The second filling layer 1142 is comprised of a transparent material selected from the group consisting of epoxy and silicone. The second filling layer 1142 contains a number of second phosphors 114b therein. The second filling layer 1142 has one portion adjacent to the LED chip 1120 and another portion away from the LED chip 1120. The second phosphors 114b are disposed in the one portion adjacent to the LED chip 1120. That is to say, the second phosphors 114b are disposed at an interface between the second filling layer 1142 and the LED chip 1120. The second phosphors 114b surround the LED chip 1120 and are formed on the surface of the LED chip 1120. The second phosphors 114b are configured for converting the color of the light emitting from the LED chip 1120 to green. In the present embodiment, the second phosphors 114b are green phosphors. When excited, the LED chip 1120 emits blue light. The blue light is then converted to green light by action of the second phosphors 114b then emitted from the second filling layer 1142.

In this embodiment, the second filling layer 1142 further contains a green dye (not shown). The green dye can be disposed in the portion away from the LED chip 1120. The green dye is configured for absorbing any blue light that does not interact with the second phosphors 114b assuring only green light is emitted from the second filling layer 1142.

The third sub-pixel unit 11c is configured for emitting blue light. Similarly, the third sub-pixel unit 11b includes a LED chip 1120 and a third filling layer 1144 encapsulating the LED chip 1120. The third filling layer 1144 is comprised of a transparent material selected from the group consisting of epoxy and silicone. In the present embodiment, when the LED chip 1120 is excited it emits blue light that passes through and emits from the third filling layer 1144.

The red light emitting from the first sub-pixel unit 11a, the green light emitting from the first sub-pixel unit 11b and the blue light emitting from the first sub-pixel unit 11c are combined in proper ratio to form a pre-determined color to be displayed. Because the LED chip 1120, the LED chip 1120, and the LED chip 1120 are all the same type and emit the same color of light they also have identical luminescence decay characteristics and voltage requirements. Thus, the blue shift phenomenon can be effectively avoided, thereby obtaining an excellent lasting desired color. In addition, difficulty in designing the corresponding electrical circuit is reduced.

In the present embodiment, the full color LED display 10 further includes a substrate 110 and a number of baffle walls 116. The baffle walls 116 extend from a surface 1101 of the substrate 110. The baffle walls 116 and the substrate 110 define a number of holding cavities 1160 for receiving the first sub-pixel unit 11a, the second sub-pixel unit 11b and the third sub-pixel unit 11c respectively. Preferably, each of the baffle walls 116 is perpendicular to the surface 1101 of the substrate 110. The substrate 110 is comprised of a ceramic material selected from the group consisting of aluminum oxide (Al₂O₃), magnesium oxide (MgO), aluminum nitride (AlN), boron notride (BN), silicon oxide (SiO₂) and beryllium oxide (BeO).

The full color LED display 10 further includes a printed circuit board 113. The substrate 110 is disposed on the printed circuit board 113. The printed circuit board 113 is electrically connected with the LED chip 1120, the LED chip 1120 and the LED chip 1120.

Additionally, the full color LED display 10 further comprises a diffusing layer 17 covering the first filing layers 1140, the second filling layers 1142 and the third filling layers 1144 of the pixel units 11. The diffusing layer 17 has a first surface 171 and an opposite second surface 172. The first surface 171 is contacted with the first filing layers 1140, the second filling layers 1142 and the third filling layers 1144 of the pixel units 11. The diffusing layer 17 contains a number of diffusers 173. The diffusing layer 17 is comprised of a transparent material selected from the group consisting of epoxy and silicone. The diffusers 173 are selected from the group consisting of titanium dioxide (TiO₂) particles, poly carbonate (PC) particles, polymethyl methacrylate (PMMA) particles, fused silica particles, aluminum oxide (Al₂O₃) particles, magnesium oxide (MgO) particles and sialon particles. It is noted that the diffuser 173 can be other transparent oxynitride particles. In the present embodiment, the diffusers 173 each are in a sphere shaped. Diameters of the diffusers 173 are less than 3 microns. A refractive index of the diffusing layer 17 is different from that of the diffusers 173. The refractive index of the diffusers 173 is in a range from 1.1 to 2.4. The diffusing layer 17 is configured for diffusing the light emitted from the pixel units 11, and the diffused light is emitting from the second surface 172.

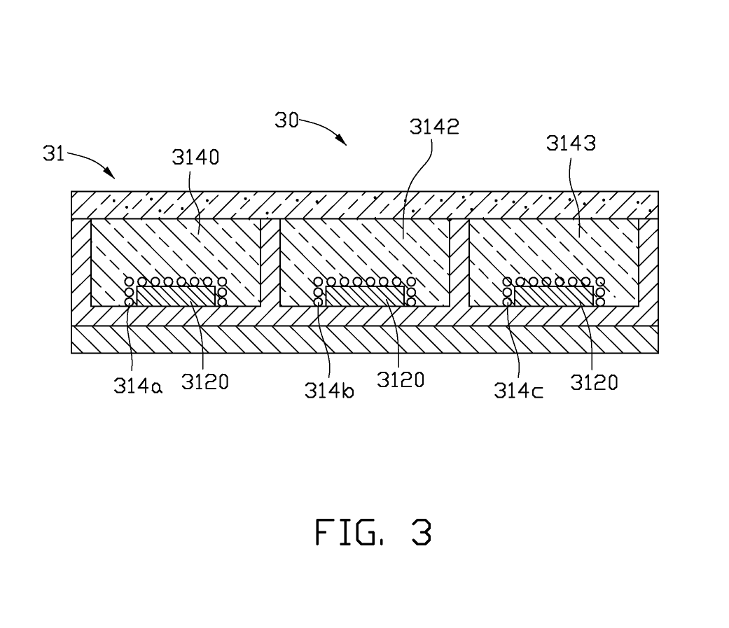

Referring to the FIG. 3, an exemplary pixel unit 31 of a full color LED display 30 according to a second embodiment is shown. The full color LED display 30 is similar to the full color LED display 10 in the first embodiment. However, the LED chips 3120 each emit ultraviolet (UV) light. The third filling layer 3144 contains a number of third phosphors 314c therein. The third filling layer 3144 has one portion adjacent to the LED chip 3120 and another portion away from the LED chip 3120. The third phosphors 314c are disposed in the one portion adjacent to the LED chip 3120. That is to say, the third phosphors 314c are disposed at an interface between the third filling layer 3144 and the LED chip 3120. The third phosphors 314c surround the third LED chip 3144 and are formed on the surface of the LED chip 3120. In the present embodiment, the third phosphors 314c are blue phosphors.

A number of first phosphors 314a are configured for converting the UV light emitted from the LED chip 3120 to the red light. A number of second phosphors 314b are configured for converting the UV light emitted from the LED chip 3120 to the green light. The third phosphors 314c are configured for converting the UV light emitted from the LED chip 3120 to the blue light. Advantageously, a red dye (not shown) in the first filling layer 3140 and a green dye (not shown) in the second filling layer 3142 are configured for absorbing any UV light that doesn't interact with the first phosphors 314a and the second phosphors 314b, assuring only the red light and the blue light are respectively emitted from the first filling layer 3140 and the second filling layer 3142. It is noted that the third filling layer 1140 can further contain a blue dye (not shown) therein. The blue dye can be disposed in the portion away from the LED chip 3120. The blue dye is configured for absorbing UV light as the above dyes.

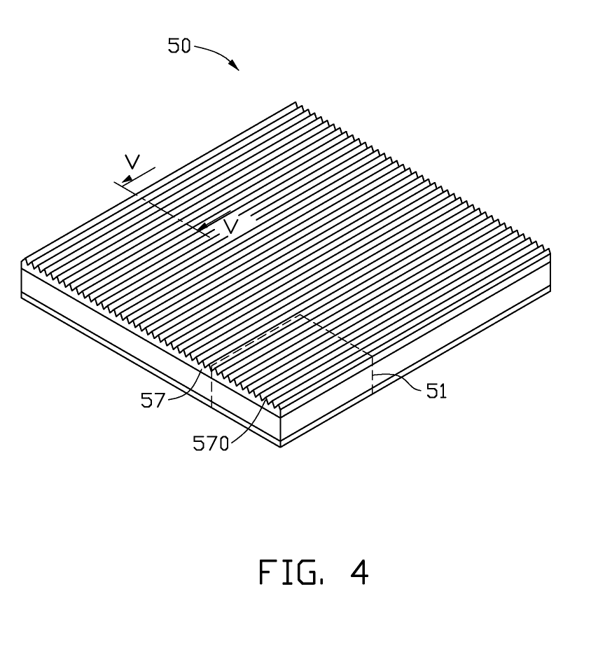

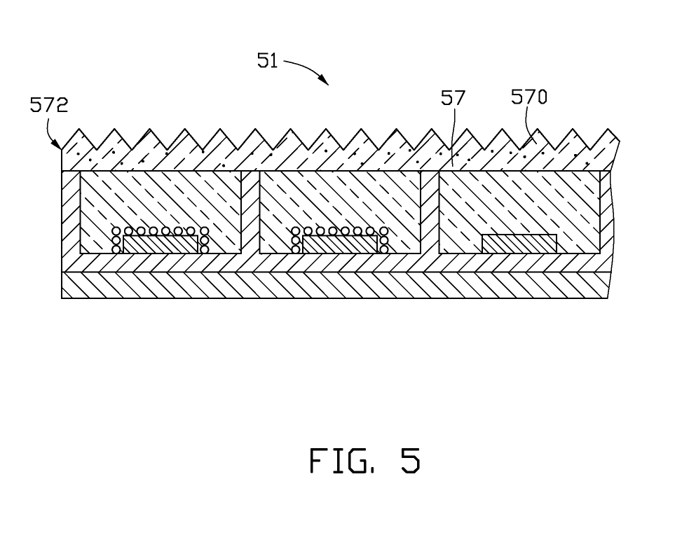

Referring to the FIG. 4 and FIG. 5, an exemplary full color LED display 50 and a pixel unit 51 of the full color LED display 50 according to a third embodiment are shown. The full color LED display 50 is similar to the full color LED display 10 in the first embodiment except for a diffusing layer 57.

In the present embodiment, a number of microstructures 570 are disposed on a second surface 572. The microstructures 570 include a number of elongated protrusions extending from the second surface 572. The elongated protrusions are parallel to each other. A cross-section of each of the elongated protrusions has a triangle configuration. Light passing through such microstructures 570 can be focused, thereby increasing brightness of the light.

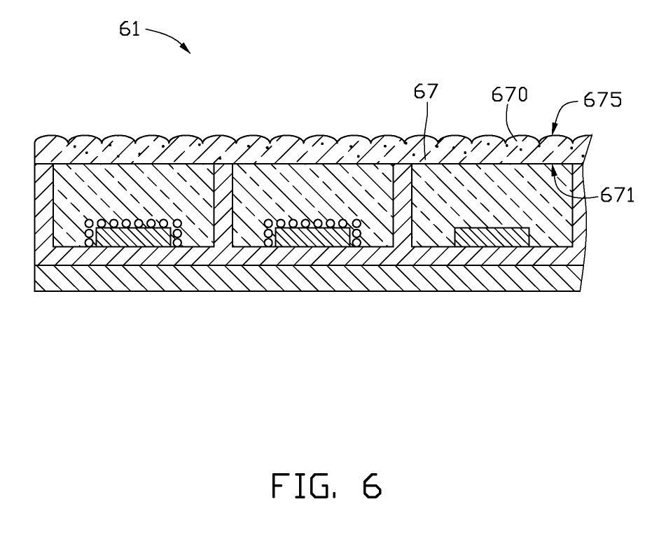

Referring to the FIG. 6, an exemplary pixel unit 61 of a full color LED display 60 according to a fourth embodiment is shown. The full color LED display 60 is similar to the full color LED display 50 in the first embodiment except for microstructures 670. In the present embodiment, each of elongated protrusions of the microstructures 670 has an elongated convex surface 675 opposite to a first surface 671.

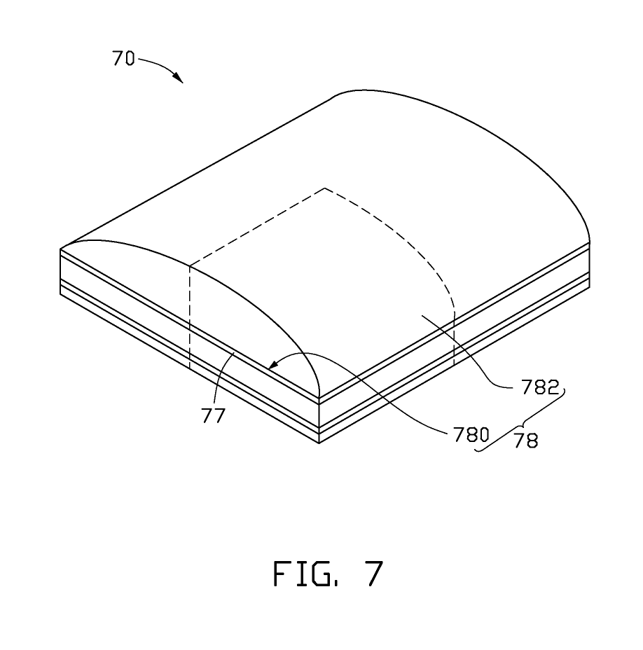

Referring to the FIG. 7, an exemplary full color LED display 70 according to a fifth embodiment is shown. The full color LED display 70 is similar to the full color LED display 10 in the first embodiment. However, the full color LED display 70 further includes a lens unit 78 disposed on the diffusing layer 77. The lens unit 78 has a plane 780 and an opposite convex surface 782. The plane 780 is contacted with a diffusing layer 77. Light passing through the lens unit 78 can be further focused to increase brightness of the emitted light.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A full color LED display, comprising:
a plurality of pixel units, each of the pixel units comprising a first sub-pixel unit, a second sub-pixel unit and a third sub-pixel unit,
the first sub-pixel unit comprising a first LED chip for emitting first light of a first wavelength and a first phosphor layer associated with the first LED chip for converting the first light emitted from the first LED chip into second light of a second wavelength,
the second sub-pixel unit comprising a first LED chip and a second phosphor layer associated with the first LED chip, for converting the first light emitted from the first LED chip into third light of a third wavelength, and
the third sub-pixel unit comprising a first LED chip for emitting the first light.

2. The full color LED display of claim 1, wherein the first light is blue light.

3. The full color LED display of claim 2, wherein the second light is red light, and the third light is green light.

4. The full color LED display of claim 2, wherein the first phosphor layer is a red phosphor layer, and the second phosphor layer is a green phosphor layer.

5. The full color LED display of claim 4, wherein the first phosphor layer surrounds the first LED chip of the first sub-pixel unit, and the second phosphor layer surrounds the first LED chip of the second sub-pixel unit.

6. The full color LED display of claim 5, wherein the first sub-pixel unit further comprises a red dye, and the second sub-pixel unit further comprises a green dye.

7. The full color LED display of claim 1, wherein the first light is UV light, and the third sub-pixel unit comprises a third phosphor layer associated with the first LED chip, for converting the first light emitted from the first LED chip into fourth light of a fourth wavelength.

8. The full color LED display of claim 7, wherein the third phosphor layer is configured for converting the first light into blue light.

9. The full color LED display of claim 7, wherein the first phosphor layer is a red phosphor layer, the second phosphor is a green phosphor layer, and the third phosphor layer is a blue phosphor layer.

10. The full color LED display of claim 9, wherein the first phosphor layer surrounds the first LED chip of the first sub-pixel unit, the second phosphor layer surrounds the first LED chip of the second sub-pixel unit, and the third phosphor layer surrounds the first LED chip of the third sub-pixel unit.

11. The full color LED display of claim 10, wherein the first sub-pixel unit further comprises a red dye the second sub-pixel unit further comprises a green dye, and the third sub-pixel unit further comprises a blue dye.

12. The full color LED display of claim 1, further comprising a diffusing layer covering the first, second and the third pixel units.

13. The full color LED display of claim 12, wherein the diffusing layer comprises a plurality of diffusers selected from the group consisting of titanium dioxide particles, poly carbonate particles, polymethyl methacrylate particles, fused silica particles, aluminum oxide particles, magnesium oxide particles and sialon particles.

14. The full color LED display of claim 11, wherein a refractive index of the diffusers is in a range from 1.1 to 2.4.

15. The full color LED display of claim 12, wherein the diffusing layer comprises a first surface and an opposite second surface, the first surface is in contact with the first, second and third pixel units, and a plurality of microstructures is formed on the second surface.

16. The full color LED display of claim 15, wherein the microstructures comprises a plurality of elongated protrusions extending from the second surface, and the elongated protrusions are parallel to each other.

17. The full color LED display of claim 16, wherein a cross-section of each of the elongated protrusions has a triangular configuration.

18. The full color LED display of claim 16, wherein each of the elongated protrusion has an elongated convex surface opposite to the first surface.

19. The full color LED display of claim 12, further comprising a lens unit having a plane surface and an opposite convex surface, and the plane surface is in contact with the diffusing layer.

20. The full color LED display of claim 1, further comprising a substrate and a plurality of partitioning walls extending from the substrate, the partitioning walls and the substrate cooperatively defining a plurality of cavities receiving the first, second and third sub-pixel units therein.
